(19) United States
(12) Patent Application Publication
(10) Pub. No.: US 2009/0218321 A1
(43) Pub. Date: Sep. 3, 2009

(54) Shape Memory Implant Heating Device

(75) Inventor: Richard B. Ashman, New Orleans, LA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(73) Assignee: INTELIFUSE, INC., New Orleans, LA (US)

(21) Appl. No.: 12/279,465

(22) PCT Filed: Feb. 14, 2007
(86) PCT No.: PCT/US2007/003738

§ 371 Date: Jan. 14, 2009

Related U.S. Application Data
(60) Provisional application No. 60/773,259, filed on Feb. 14, 2006.

(51) Int. Cl. H05B 3/03

(52) U.S. Cl. 219/50

(57) ABSTRACT

A device (20) or system (60) for heating heat-transformable shape memory implants used in surgery applications. The case (22) is configured to be hand-held by a user. The device (20) also includes a variable electronic power supply (24) contained within the case (22). The variable electronic power supply (24) includes a predetermined size and quantity of batteries (34). The variable electronic power supply (24) is varied by varying the predetermined size and quantity of batteries (34) according to the characteristics of the shape memory implants. The device (20) further includes conductive electrodes (26) extending from the case (22). The conductive electrodes (26) are electrically joined with the electronic power supply (24) in the interior chamber (30) of the case (22) via an electrical connection (36) to form a power circuit (38). A user activated switch (28) is joined with the electronic power supply (24). The user activated switch (28) is accessible from one of the exterior surfaces (32) of the case (22) and is configured to activate and deactivate the power circuit (38).

### BACKGROUND OF THE INVENTION

1. Field of the Invention

The present invention generally relates to devices for heating shape memory transformable surgical clamps used in implanted surgical applications. More particularly, the present invention relates to a device for heating nickel/titanium alloy shape memory implant clamps, which includes a cordless, portable, variable power source.

2. Description of Related Art

Heating or cooling shape memory transformable surgical clamps are initially supplied in an open configuration at ambient temperature. After surgical placement, a quantity of heat is then provided to close the clamp and thus provide tissue support. In other configurations, the clamp can be transformed back to its original shape by cooling. Hence, the surgical implant can be made to release its fixation to the tissue. Various configurations of implants are available. In practice, surgical constraints require these surgical devices (or implants) to be manufactured to extremely restrictive specifications.

In the surgical context, it is desired that a heating or cooling device to be able to transform many different types of clamps, whether they be mono-cortical or bicortical, bipode or quadripode clamps, and irrespective of their cross sectional shape or size, or the amount of shape memory metal used in their design. Many prior art designs are limited in the variety of clamps they can transform. It is also desired that a heating or cooling device include a reliable and effective safety system to prevent accidental bone necroses due to excessive heating or cooling applied by the device. Many prior art devices fail to include reliable safety systems. A common problem with the heating devices used to transform shape memory alloy implants is the inability to see the implant transform. The legs of these implants are imbedded in bone or tissue and in some cases do not move when transformed, but rather begin to exert forces on the tissue. Many prior art devices are not capable of determining when enough energy has been transferred to the implant so it transforms completely but does not get so hot as to damage the surrounding tissue.

While devices are available that can provide the heating required to transform the implants in a surgical setting, it has become evident that in some surgical settings, surgeons need a cordless device, that is less constraining than the presently available AC wall current powered devices. Similarly, it is sometimes necessary to have multiple heating devices or heating device having various sizes of power sources available at a particular surgical institution. These systems must be ready for multiple emergency surgeries with little prior notice. For example, at large trauma centers, or at military evacuation hospitals, many simultaneous trauma cases may be presented after long periods of little or no trauma activity. Hence, there is a need for inexpensive presterilized heating systems that could be stored with the surgical implants to be ready at a moment's notice.

### SUMMARY OF THE INVENTION

One aspect of the invention is a device for heating heat-transformable shape memory implants used in surgery applications. The device includes a case having an interior chamber and exterior surfaces. The case is configured to be hand-held by a user. The device also includes a variable electronic power supply contained within the interior chamber of the case. The variable electronic power supply includes a predetermined size and quantity of batteries. The variable electronic power supply is varied by varying the predetermined size and quantity of batteries according to the characteristics of the shape memory implants. The device further includes conductive electrodes extending from the case. The conductive electrodes are electrically joined with the electronic power supply in the interior chamber of the case via an electrical connection to form a power circuit. A user activated switch is joined with the electronic power supply. The user activated switch is accessible from one of the exterior surfaces of the case and is configured to activate and deactivate the power circuit.

Another aspect of the invention is a system for heating a heat-transformable. shape memory surgical device. The system includes a sealed, sterilizable housing, which is configured to be hand-held by a user, a thermal probe for heating the shape memory surgical device, the thermal probe being connected with the housing, a variable electronic power supply contained within the housing, the variable electronic power supply including a predetermined size and quantity of batteries, wherein the variable electronic power supply is varied by varying the predetermined size and quantity of batteries according to the characteristics of the shape memory surgical device, and a printed circuit board positioned within the housing. The printed circuit board includes a system controller having a power circuit for controlling the receipt and distribution of heating power from the variable electronic power supply to the thermal probe, a feedback circuit for measuring a condition of the shape memory surgical device via the thermal probe, and a control circuit for receiving data from the feedback circuit and adjustably controlling an amount of heating power that the power circuit distributes to the thermal probe.

### BRIEF DESCRIPTION OF THE DRAWINGS

For the purpose of illustrating the invention, the drawings show a form of the invention that is presently preferred. However it should be understood that the present invention is not limited to the precise arrangements and instrumentalities shown in the drawings, wherein:

FIG. 1 is a transparent isometric side view of a device according to one embodiment of the present invention;

FIG. 2 is a partial side-section view of one embodiment according to the present invention;

FIG. 3 is side sectional view of a handheld battery-powered device according to one embodiment of the present invention;

FIG. 4 is an enlarged partial view of an electrode tip according to one embodiment of the present invention; and

FIG. 5 is an enlarged partial view of an electrode tip according to one embodiment of the present invention

### DETAILED DESCRIPTION

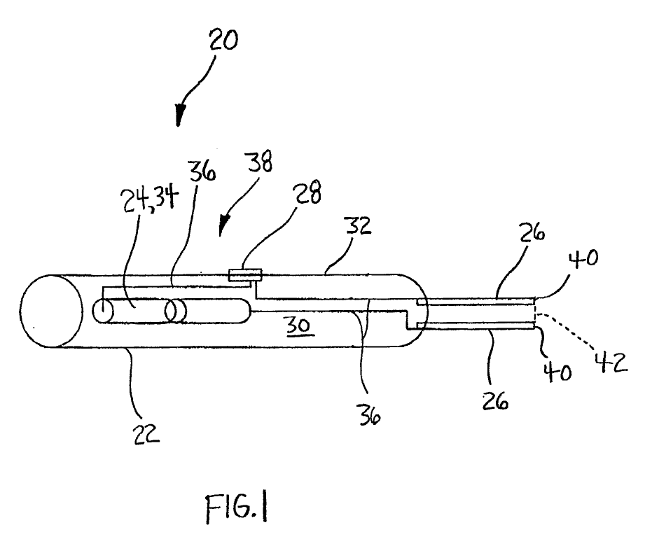

Referring now to the drawings in which like reference numerals indicate like parts, and in particular, to FIG. 1, one aspect of the present invention is a device 20 for heating heat-transformable shape memory implants (not shown) used in surgery applications. In one embodiment, device 20 includes a case 22 that contains a variable electronic power supply 24 that is joined with conductive electrodes 26 and controlled by a user activated switch 28. In use, electrical current is generally supplied automatically when contact is made between conductive electrodes 26 and the shape memory implant.

Case 22 includes an interior chamber 30 and exterior surfaces 32. Case 22 is generally configured to be hand-held by a user and typically fabricated from materials, e.g., metals and plastics, etc., that can be sterilized by a variety of means, e.g., bulk processes such as ethylene oxide gas or gamma ray ionization.

Variable electronic power supply 24 is contained within interior chamber 30 of case 22. Variable electronic power supply 24 includes a predetermined size and quantity of batteries 34. The strength or maximum amount of power available from variable electronic power supply 24 is varied or adjusted by varying the predetermined size and quantity of batteries 34 according to the characteristics of the shape memory implants, e.g., in accordance with the amount of power required to transform a particular shape memory implant. To minimize the possibility of tissue necrosis, the adjustment of variable electronic power supply 24 is configured so that the amount of heat delivered to a given shape memory implant cannot cause the temperature of the implant to exceed a maximum value, e.g., 55° C.

Conductive electrodes 26 extend from case 22 and are electrically joined with variable electronic power supply 24 in interior chamber 30 of case 22 via an electrical connection 36 to form a power circuit 38. Conductive electrodes 26 include a tip 40, which can be formed from a conductive material to supply the shape memory implant (not shown) with electrical current through which it is heated due to the electrical resistance of its material. Electrical or thermal conductivity between tip 40 and the shape memory implants may be improved by using a more conductive material, or plating with a more conductive material. Tips 40 can be fashioned of a conductive material with ends that have sharp ridges to provide a non-slip contact between the implant and the tip or the tip can be saddle-shaped to help prevent the tips from slipping on the surface of the implant. In one embodiment, the conductive material is one of gold, aluminum, silver, and a combination thereof. In another embodiment, tip 40 is formed from a resistive material to supply the shape memory implant (not shown) with electrical current through which it is heated due to the electrical resistance of its material. The resistive material can be one of carbon, graphite, and a combination thereof. In another embodiment, conductive electrodes 26 can be spanned by a resistive wire or ribbon 42 through which electric current is passed. When resistive wire 42 is brought into contact with a shape memory implant and the user activates the current, the shape memory implant is heated by conduction with the resistive wire or ribbon.

User activated switch 28, which is generally positioned so as to be accessible from one of exterior surfaces 32 of case 22, is joined with variable electronic power supply 24. User activated switch 28 is typically configured to activate and deactivate power circuit 38.

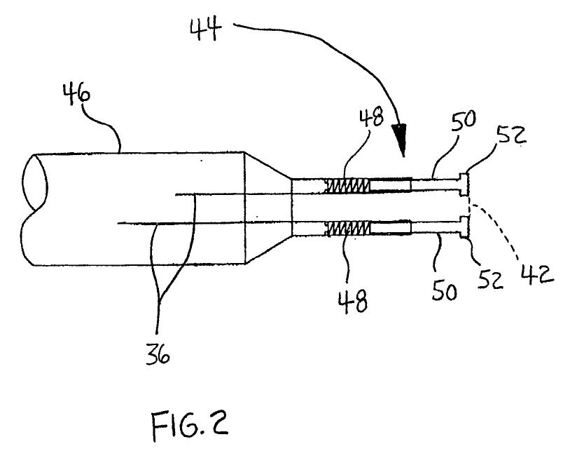

Referring now to FIG. 2, in another embodiment conductive electrodes 26 can be conductive tubular electrodes 44. Each of conductive tubular electrodes 44 has a tubular body 46, an internal compression spring 48 positioned within the tubular body, and conductive tips 50. Conductive tips 50 can be rod-shaped and are configured to slide within tubular body 46. Tubular body 46 can be molded into case 22 of device 20 by an insulating material (not shown). Internal compression springs 48 can be inserted between conductive tips 50 and tubular body 46, within the tubes to provide a certain amount of give or flexibility between the tips and body of device 20. Without flexibility, a user would be required to hold device 20 perfectly still, with no up or down or angular motion while current was being applied to the implant. Internal compression spring 48 is retained at least partially within tubular body 46 by crimps (not shown) in the tubular body. Conductive tips 50 can include roughened conductive pads 52 and generally are configured so as to move independently of one another. Each of conductive tips 50 is typically retained at least partially within tubular body 46 by crimps (not shown) in the tubular body. With this tip design, device 20 does not have to be held in perfect alignment with the implant to insure contact between conductive tips 50 and an implant surface.

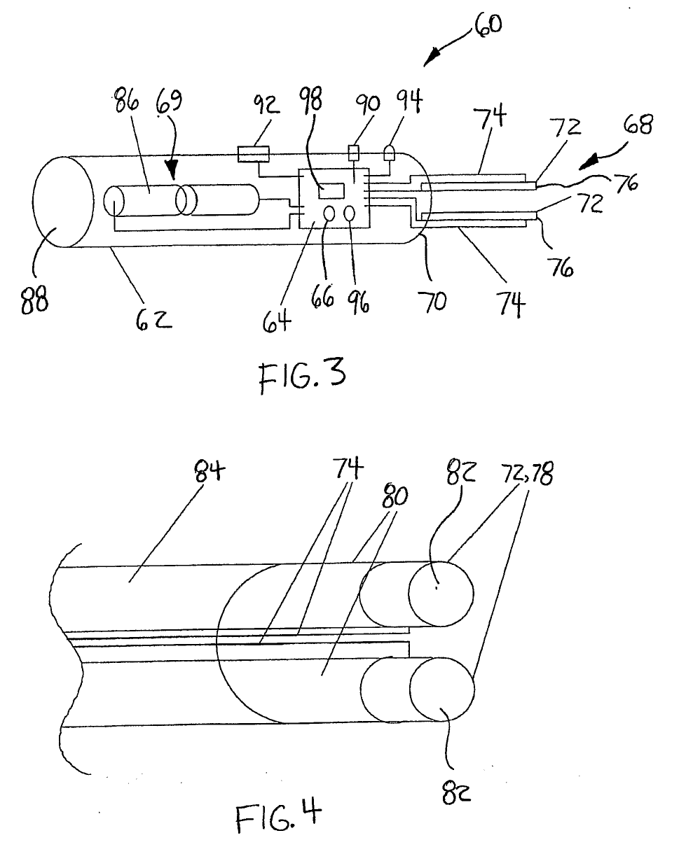

Referring now to FIG. 3, another aspect of the present invention is a system 60 for heating a heat-transformable shape memory surgical device (not shown). In one embodiment, system 60 is contained in a sealed, sterilizable handheld housing 62. System 60 includes a printed circuit board 64 including a system controller 66, both of which are contained in housing 62. System controller 66 is connected with a thermal probe 68, which extends from housing 62, for heating the shape memory surgical device. A variable electronic power supply 69, which is contained within housing 62, provides power for heating the shape memory surgical device.

Housing 62 is generally sealed such that it is sterilizable and can withstand the conditions of an autoclave without damaging any of its internal components such as system controller 66. The components of system 60 generally form a handheld device in the form of housing 62.

Thermal probe 68, which is used to heat the shape memory surgical device, is connected with housing 62 via printed circuit board 64 and extends from an end 70 of the housing. Referring now to FIG. 4, in one embodiment, thermal probe 68 is formed from a pair of electrodes 72, which are used to apply an electric current to the shape memory surgical device. Electrodes 72 cause the shape memory surgical device to be heated by its resistance to electric current, rather than by heat conduction or radiation. As described in greater detail below, thermal probe 68 may also be defined by thermal contacts other than conventional electrodes such as electrodes 72.

A current sensing wire 74 may be joined with each of electrodes 72 to measure the current flow between a tip 76 of each electrode and the shape memory surgical device. Electrodes 72 may be formed from conductive materials such as gold, aluminum, silver, or a combination thereof. Alternatively, electrodes 72 may be formed from resistive materials such as carbon, graphite, or a combination thereof.

In one embodiment, as illustrated in FIG. 4, electrodes 72 formed from two graphite rods 78, both of which are covered by an insulating material 80, may be placed in close contact to each other. Current sensing wires 74 are attached to each of rods 78. Current sensing wires 74 are insulated from each other and graphite rods 78 except at their point of contact with rods adjacent each tip 82. Current sensing wires 74 are used to measure the current flow close tips 82. Electrodes 72 may be formed into a cylindrical shape using an insulation 84 to facilitate placement into a surgical site.

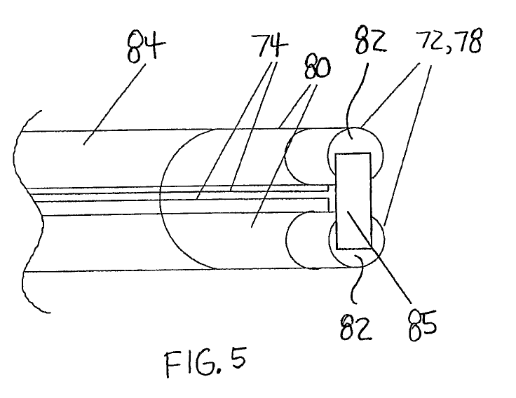

Referring now to FIG. 5, in one embodiment, a resistive wire or ribbon 85 may be joined with and extend between electrodes 72. A current is passed through wire or ribbon 85. Wire or ribbon 85, rather than electrodes 72, is brought into contact with the shape memory surgical device to heat the device.

Referring again to FIG. 3, printed circuit board 64 is typically positioned within housing 62 to ensure it is protected during sterilization. Printed circuit board 64 includes system controller 66, which is generally defined by a power circuit (not shown) for controlling the receipt and distribution of heating power to each thermal probe 68, a feedback circuit (not shown) for measuring a condition of the shape memory surgical device via the thermal probe, and a control circuit (not shown) for receiving data from the feedback circuit and adjustably controlling an amount of heating power that the power circuit distributes to the thermal probe. If thermal probe 68 includes electrodes 72, system controller 66 will control the flow of electrical current to the electrodes.

The control circuit typically includes an automatic-cutout circuit (not shown) for terminating the distribution of heating power to thermal probe 68 after a specific amount of time or upon the occurrence of a predetermined condition. System 60 may also incorporate one or more digital microprocessors (not shown) for determining a proper temperature and time to heat the shape memory surgical device so that the temperature generated in the shape memory surgical device does not exceed a predetermined maximum value. The one or more digital microprocessors are in cooperation with the control circuit. The shape memory surgical devices are typically designed to be shape transformed at specific temperatures, usually between 45 and 50 degrees Celsius. The control circuit ensures that system 60 heats the shape memory surgical devices to a temperature slightly higher than that needed for shape transformation, but no more. A temperature limit allows the implant to be shape transformed, but not induce tissue necrosis from over heating.

System 60 includes variable electronic power supply 69 for supplying heating power to the power circuit and system in general. Variable electronic power supply 69 typically includes a predetermined size and quantity of batteries 86 contained within housing 62. Variable electronic power supply 69 can be adjusted or varied by varying the predetermined size and quantity of batteries 86 according to the characteristics of the shape memory surgical device. In one embodiment, system 60 is configured to include sensors (not shown) or another mechanism for supplying heating power automatically when thermal probe 68 is brought into contact with the shape memory surgical device.

System 60 may include manual switches such as a momentary switch 90 and a multi-position switch 92, which are positioned on housing 62. Momentary switch 90 allows a user to manually activate the system. Multi-position switch 92 allows a user to manually set the amount of time or the amount of current to be delivered to the shape memory surgical device. Visual and audible signaling features such as an LED 94, piezo beeper 96, and a digital or analog readout 98 alert a user when a certain condition has occurred, e.g., the desired temperature of the shape memory surgical device was achieved, a predetermined amount of operation time elapsed, the device moved to a desired shape, or a predetermined amount of current passed through the device.

Prior to use of system 60, the appropriate size and number of batteries 86 are selected according to the size and material of the shape memory surgical device to be transformed. In use, system 60 is operated by first selecting a position of multi-position switch 92 appropriate for the size of the shape memory surgical device to be transformed. Moving multi-position switch 92 to one of several shape memory surgical device size positions illuminates LED 94. LED 94 indicates power is available to the unit.

Next, tip 76 of thermal probe 68 is placed in contact with one side of the shape memory surgical device. When electrodes 72 are placed in contact with the shape memory surgical device, current sensing wires 74 sense the completion of the circuit. Upon completion of the conductivity circuit, a user presses momentary switch 90 and current is supplied to electrodes 72 for a number of seconds until an audible signal from piezo beeper 96 is heard. At this time, LED 94 changes color indicating that both contact is being made with the shape memory surgical device and the power circuit is delivering a specific current to tip 76. LED 94 changes back to its original color at the end of the heating sequence. Current sensing wires 74 are provided to more precisely measure the current at each of tips 76. After a specific amount of time has passed, the power circuit stops delivering current.

The shape memory implants are designed to be shape transformed at specific temperatures, usually between 45° C. and 50° C. This heating device describe here will be used to heat the implants to a temperature slightly higher than that needed for shape transformation. Device 20 will limit the current, and hence the temperature of the shape memory implants, via the inherent current limit that a specific choice of battery can deliver. The current supplied will allow the implant to be heated to be shape transformed, but not induce tissue necrosis from over heating. The use of an electrode tip design in device 20 will cause the implant to be heated by its resistance to electric current, rather than by heat conduction or radiation. In use, a surgeon would observe the implant as it is heated by device 20 and transforms its shape. A careful choice of battery capacity for each implant size would be used to keep the heating device from generating too great a temperature. While this scheme is less sophisticated than that of providing the device with a timer, or other control circuit, it is the simplest and least expensive embodiment, thus satisfying the need for a low cost device that can be provided to the surgeon presterilized for single patient use.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A device (20) for heating heat-transformable shape memory implants used in surgery applications, said device (20) comprising:
a case (22) including an interior chamber (30) and exterior surfaces (32), said case (22) being configured to be hand-held by a user;
a variable electronic power supply (24) contained within said interior chamber (30) of said case (22), said variable electronic power supply (24) further comprising a predetermined size and quantity of batteries (34), wherein said variable electronic power supply (24) is varied by varying said predetermined size and quantity of batteries (34) according to the characteristics of the shape memory implants;
conductive electrodes (26) extending from said case (22), said conductive electrodes (26) being electrically joined with said electronic power supply (24) in said interior chamber (30) of said case (22) via an electrical connection (36) to form a power circuit (38); and
a user activated switch (28) joined with said electronic power supply (24), said user activated switch (28) being accessible from one of said exterior surfaces (32) of said case (22), wherein said user activated switch (28) is configured to activate and deactivate said power circuit (38).

2. A device (20) according to claim 1, wherein said conductive electrodes (26) includes a tip (40) formed from a conductive material.

3. A device (20) according to claim 2, wherein said conductive material is one of gold, aluminum, silver, and a combination thereof.

4. A device (20) according to claim 1, wherein said conductive electrodes (26) includes a tip (40) formed of a resistive material.

5. A device (20) according to claim 4, wherein said resistive materials is one of carbon, graphite, and a combination thereof.

6. A device (20) according to claim 1, wherein said conductive electrodes (26) are spanned by a resistive wire or ribbon (42) through which electric current is passed.

7. A device (20) according to claim 1, where electrical current is supplied automatically when contact is made between said conductive electrodes (26) and the shape memory implant.

8. A device (20) according to claim 1, wherein said conductive electrodes (26) further comprise conductive tubular electrodes (44), wherein each of said conductive tubular electrodes (44) has a tubular body (46), an internal compression spring (48) positioned within said tubular body (46), and conductive tips (50), and said conductive tips (50) are configured to slide within said tubular body (46).

9. A device (20) according to claim 8, wherein said conductive tips (50) include roughened conductive pads (52).

10. A device (20) according to claim 8, wherein said conductive tips (50) move independently of one another.

11. A device (20) according to claim 8, wherein each of said conductive tips (50) are retained at least partially within said tubular body (46) by crimps in said tubular body (46).

12. A device (20) according to claim 8, wherein said internal compression spring (48) is retained at least partially within said tubular body (46) by crimps in said tubular body (46).

13. A system (60) for heating a heat-transformable shape memory surgical device, said system (60) comprising:
a sealed, sterilizable housing (62), said housing (62) being configured to be hand-held by a user;
a thermal probe (68) for heating the shape memory surgical device, said thermal probe (68) being connected with said housing (62);
a variable electronic power supply (69) contained within said housing (62), said variable electronic power supply (69) further comprising a predetermined size and quantity of batteries (86), wherein said variable electronic power supply (69) is varied by varying said predetermined size and quantity of batteries (86) according to the characteristics of the shape memory surgical device; and
a printed circuit board (64) positioned within said housing (62), said printed circuit board (64) including a system controller (66) having a power circuit for controlling the receipt and distribution of heating power from said variable electronic power supply (69) to said thermal probe (68), a feedback circuit for measuring a condition of the shape memory surgical device via said thermal probe (68), and a control circuit for receiving data from said feedback circuit and adjustably controlling an amount of heating power that said power circuit distributes to said thermal probe (68).

14. A system (60) according to claim 13, wherein said control circuit further comprises an automatic-cutout circuit for terminating the distribution of heating power to said thermal probe (68) after a specific amount of time or upon the occurrence of a predetermined condition.

15. A system (60) according to claim 13, further comprising one or more digital microprocessors for determining a proper temperature and time to heat the shape memory surgical device so that the temperature generated in the shape memory surgical device does not exceed a predetermined maximum value, wherein said one or more digital microprocessors are in cooperation with said control circuit.

16. A system (60) according to claim 13, wherein said thermal probe (68) is an electrode for applying an electric current to the shape memory surgical device.

17. A system (60) according to claim 13, further comprising current sensing wires (74) joined with said thermal probe (68), wherein said current sensing wires (74) are configured to measure a conductivity between a tip (76) of said thermal probe (68) and the shape memory surgical device.

18. A system (60) according to claim 13, further comprising a digital or analog readout (98) for indicating a condition of the shape memory surgical device.

19. A system (60) according to claim 16, wherein said electrode is formed from one of gold, aluminum, silver, or a combination thereof.

20. A system (60) according to claim 16, wherein said electrode is formed from one of carbon, graphite, or a combination thereof.

21. A system (60) according to claim 13, further comprising a second thermal probe (68) and a resistive wire or ribbon joined with and extending between said thermal probe (68) and said second thermal probe (68).

22. A system (60) according to claim 13, further comprising means for supplying heating power automatically when said thermal probe (68) is brought into contact with the shape memory surgical device.
